(19) United States
(12) Patent Application Publication
(10) Pub. No.: US 2012/0310444 A1
(43) Pub. Date: Dec. 6, 2012

(54) Installing Terranean-Based Systems

(75) Inventors: John S. Fitch, Los Altos, CA (US); David K. Fork, Mountain View, CA (US)

(73) Assignee: Google Inc., Mountain View, CA (US)

(21) Appl. No.: 13/150,300

(22) Filed: Jun. 1, 2011

(51) Int. Cl. G06F 19/00; G05D 1/00

(52) U.S. Cl. 701/2; 701/50

(57) ABSTRACT

A mobile system includes a vehicle operable to traverse a terranean surface; one or more installers mounted to the vehicle, each installer configured to move in at least two degrees of freedom relative to the terranean surface and install one or more system components; a power module coupled to the one or more installers, the power module configured to provide operating power to the one or more installers; and a computer module. The computer module includes a memory and one or more processors operable to execute a component installation module. The component installation module is operable to direct the vehicle to a plurality of locations on the terranean surface; and direct an operation of the one or more installers to install at least one system component at one of the plurality of locations.

### TECHNICAL BACKGROUND

This disclosure relates to systems and methods for installing terranean-based systems, such as solar energy systems.

### BACKGROUND

Solar energy management, collection, and use can often help alleviate energy problems around the world. In particular, solar energy systems such as photovoltaic (“PV”) systems, which generate electrical energy from solar energy can reduce dependence on fossil fuels or other power generation techniques. Additionally, solar energy may be used to generate heat that can subsequently be used in power generation systems. In some cases, solar energy collection systems may include multiple heliostats that reflect solar energy to a receiver. The receiver may then use solar energy for one or more purposes.

For optimal operation, heliostats should move precisely and maintain a precise aiming angle, even when acted upon by external forces. For instance, it may be desirable to maintain an angle of a beam of sunlight reflected by the heliostat to within +/−1 milliradian. Substantial wind forces on a planar object, such as a heliostat, may apply forces and torques which tend to knock the beam off-target. As such, heliostats, may require an operational platform and/or structure that remains stable even when acted-upon by external forces.

Installing heliostats, or other solar energy systems, on or in a terranean surface may be a significant task. In some instances, it may involve grading the land to remove rocks, brush, and uneven ground. It may also include significant effort by a survey team in laying out optimal positions of the solar energy systems. Typically, a crew installs the systems, which usually require holes to be (or to have been previously) formed in the surface. All of the aforementioned tasks may require preparation time, equipment, materials, and accuracy.

As one example of some of the difficulties encountered, buried rocks may be numerous at certain locations of the terranean surface in which installation of the solar energy systems are desirable. Pre-location of rock obstacles may improve a design layout of the solar energy systems (e.g., in an array) and may increase the avoidance of waste and rework.

### SUMMARY

In one general embodiment, a mobile apparatus for installing solar energy system components includes: a mobile vehicle operable to traverse a terranean surface; one or more installers mounted to the mobile vehicle, where each installer is configured to move in at least two degrees of freedom relative to the terranean surface and install one or more components of a solar energy system; a power module coupled to the one or more installers, where the power module configured to provide operating power to the one or more installers; and a computer module. The computer module includes a memory storing a component installation module; and one or more processors operable to execute the component installation module. The component installation module is operable when executed to: direct the mobile vehicle to a macro-position of a location on the terranean surface suitable for installation of the solar energy system; at the macro-position of the location, adjust at least one of the installers to a micro-position of the location within the macro-position; and direct an operation of the adjusted installer to install a component of the solar energy system at the micro-position of the location.

In another general embodiment, a method for installing at least a portion of a solar energy system includes: determining, with a computing system, a plurality of locations on a terranean surface, each of the plurality of locations suitable for a solar energy system installation relative to at least one other location in the plurality of locations; for each location, directing a mobile vehicle to at or near the location, the mobile vehicle comprising one or more installers mounted to the mobile vehicle; and for each location, directing an operation of the one or more installers to install a component of the solar energy system at the terranean surface.

One or more of the general embodiments may further include one or more terranean-modifying devices mounted to the mobile vehicle, each terranean-modifying device configured to move in at least two degrees of freedom relative to the terranean surface. The component installation module may operable when executed to direct an operation of the one or more terranean-modifying devices at or near the plurality of locations.

In one or more of the general embodiments, at least one of the terranean-modifying devices may be an auger or a tamping system.

In one or more of the general embodiments, the one or more terranean-modifying devices may be mounted to a front end of the mobile vehicle in a first rack, and the one or more installers may be mounted to a back end of the mobile vehicle in a second rack.

In one or more of the general embodiments, at least one of the first or second rack may be movable in at least two degrees of freedom relative to the corresponding end of the mobile vehicle.

In one or more of the general embodiments, at least one of the installers may be a vibration post installer.

In one or more of the general embodiments, the power module may include at least one of: a battery configured to supply electrical power to at least one of the one or more post installers, and the computer module; or a photovoltaic panel configured to supply electrical power to at least one of the battery or the computer module.

In one or more of the general embodiments, the mobile vehicle may be a human-operable vehicle.

In one or more of the general embodiments, a system may further include a wireless antenna communicably coupled to the computer module, the wireless antenna configured to receive data from a location remote from the vehicle, the data comprising instructions operable when executed by the one or more processors to perform operations including modifying at least a portion of the component installation module.

In one or more of the general embodiments, the instructions may be further operable when executed by the one or more processors to perform operations including: managing the component installation module to direct the mobile vehicle to the plurality of locations on the terranean surface; and managing the component installation module to direct an operation of the one or more installers to install a support post into the terranean surface.

In one or more of the general embodiments, each of the installers may be individually movable in at least two degrees of freedom relative to the vehicle and relative to the other installers in the plurality of installers.

In one or more of the general embodiments, at least one of the plurality of installers may be individually movable in six degrees of freedom relative to the vehicle.

In one or more of the general embodiments, a system may further include a GPS module configured to determine a location of the mobile vehicle on the terranean surface.

In one or more of the general embodiments, a system may further include a signal generator configured to transmit a plurality of signals toward a location of the terranean surface ahead of the mobile vehicle during traversal of the terranean surface, and receive a plurality of reflected signals from the location. The component installation module may be further operable when executed to: receive the plurality of reflected signals from the signal generator; transform the plurality of reflected signals to one or more images representative of one or more physical characteristics of the terranean surface; and generate a model of at least a portion of the terranean surface or a subterranean zone using the one or more images.

In one or more of the general embodiments, the plurality of signals may include one of: acoustic wave signals; light wave signals; or radio frequency wave signals.

In one or more of the general embodiments, the mobile vehicle may include an articulated frame having at least two portions.

In one or more of the general embodiments, the mobile vehicle may be configured to tow a storage vehicle, and at least one of the mobile vehicle or the storage vehicle may be configured to store: one or more components of a solar energy system; and one or more components used to install the solar energy system.

In one or more of the general embodiments, a system may further include at least one of: a dozer blade mounted to the mobile vehicle and configured to grade the terranean surface during traversal of the terranean surface by the mobile vehicle; and a backhoe mounted to the mobile vehicle and configured to move at least a portion of the terranean surface.

In one or more of the general embodiments, the component may be a support post configured to support a solar power member.

In one or more of the general embodiments, the mobile vehicle may further include one or more augering devices mounted to the mobile vehicle, each augering device configured to form a borehole in the terranean surface. The vehicle may further, for at least one location, direct an operation of the one or more of the augering devices to form a borehole in the terranean surface at or near the location.

In one or more of the general embodiments, directing an operation of the one or more installers to install a support post in the terranean surface may include directing an operation of the one or more installers to install the support post in the borehole.

In one or more of the general embodiments, each location in the plurality of locations may include a macro-position and a micro-position. Operations may further include directing the mobile vehicle to the macro-position; and directing the operation of the one or more installers to install the component at the micro-position.

In one or more of the general embodiments, operations may further include: dynamically adjusting the micro-position as the mobile vehicle is arriving or at the macro-position; and directing the operation of the one or more installers to install the component at the adjusted micro-position.

In one or more of the general embodiments, operations may further include: graphically displaying each location to a user of the mobile vehicle; guiding the user towards each location through the graphical display; and providing an indication to the user that the mobile vehicle has arrived at the macro-position.

In one or more of the general embodiments, operations may further include: transmitting a plurality of signals ahead of the mobile vehicle toward the location in the plurality of locations suitable for a solar energy system installation; receiving a plurality of reflected signals from the location representative of one or more physical characteristics of the proposed location; and automatically adjusting the macro-position or the micro-position of the location based on the one or more physical characteristics of the location.

In one or more of the general embodiments, operations may further include: transforming the plurality of reflected signals to one or more images representative of one or more physical characteristics of the terranean surface or a subterranean zone; and displaying the one or more images on a graphical user interface.

In one or more of the general embodiments, the one or more images may include three-dimensional images.

In one or more of the general embodiments, determining a plurality of locations on a terranean surface, each of the plurality of locations suitable for a solar energy system installation relative to at least one other location in the plurality of locations, may include receiving data at the mobile vehicle indicating global positioning coordinates of at least a portion of the plurality of locations.

In one or more of the general embodiments, operations may further include: automatically determining a macro-position of a next location suitable for installation of a solar energy system different than a previous location; directing the mobile vehicle to the next location; and determining a micro-position of the next location.

In one or more of the general embodiments, automatically determining a macro-position of a next location suitable for installation of a solar energy system different than a previous location may include at least one of: receiving data at the mobile vehicle indicating global positioning coordinates of the next location; calculating global positioning coordinates of the next location based on a differential in global positioning coordinates between the previous location and a location of a solar energy receiver; or calculating global positioning coordinates of the next location based on a substantially fixed differential from the previous location.

In one or more of the general embodiments, directing the operation of the one or more installers to install the support post in the terranean surface at the micro-position may include at least one of: moving a rack that is mounted to the mobile vehicle and supports the one or more installers in at least two degrees of freedom relative to the mobile vehicle; and moving at least one installer in at least two degrees of freedom relative to the rack.

In one or more of the general embodiments, operations may further include at least one of: grading at least a portion of the terranean surface with a dozer blade mounted to the mobile vehicle during traversal of the terranean surface by the mobile vehicle; moving at least a portion of the graded terranean surface by a backhoe mounted to the mobile vehicle; or dispensing a portion of cement at one of the plurality of locations to supplement the terranean surface.

In one or more of the general embodiments, operations may further include: generating power on the mobile vehicle; and supplying the electrical power to one or more of the installers.

In one or more of the general embodiments, generating power on the mobile vehicle may include at least one of: generating hydraulic power with an internal combustion engine of the mobile vehicle; and generating electrical power by at least one of a solar power photovoltaic cell mounted on the mobile vehicle or the internal combustion engine of the mobile vehicle.

Various implementations of a mobile installer according to the present disclosure may include one or more of the following features and/or advantages. For example, the mobile installer may allow for the installation of one or more components of a solar energy system (e.g., a heliostat or other system) on uneven, or ungraded, ground. The mobile installer may also allow for the installation of one or more components of a solar energy system at predetermined locations in a field or landscape. In addition, the mobile installer may provide for the removal of obstacles (e.g., rocks, terranean protrusions, brush, and other obstacles) just prior to installing one or more components of a solar energy system. As such, the mobile installer may reduce time, labor, costs, and/or land impact associated with installing solar energy systems. The mobile installer may also optimize installation of solar energy systems by dynamically determining one or more locations for such systems based on a variety of factors, such as, for example, location of obstacles, location of one or more solar energy receivers, and other considerations. For instance, the mobile installer may dynamically determine such locations by ground penetrating radar (GPR), seismic imaging, and/or other technologies.

Various implementations of a mobile installer according to the present disclosure may also include one or more of the following features and/or advantages. For example, the mobile installer may efficiently install one or more support posts for corresponding solar energy systems. The mobile installer may, automatically or by driver direction, arrive at a macro position (e.g., a location within a specified macro distance of an optimal solar energy system location) of each support post and adjust to a micro position (e.g., a location within a specified micro distance less than the macro distance of an optimal solar energy system location) in order to install the support post at a precise location. In adjusting to the micro position, the mobile installer may articulate and/or pivot one or more components in two or more degrees of freedom, and, in some cases, up to six degrees of freedom. The mobile installer may also include one or more positioning systems and/or navigation guidance systems. In addition, the mobile installer may prepare a location for installation by, for example, treating a surface of the location and/or adjusting natural features at the location, thereby minimizing installation time and improving the installation. Of course, the mobile installer may be used to install or help install one or more components or systems not associated with solar energy systems, such as, for example, components or systems (or subsystems) associated with wind energy generation.

These general and specific aspects may be implemented using a device, system or method, or any combinations of devices, systems, or methods. The details of one or more implementations are set forth in the accompanying drawings and the description below. Other features, objects, and advantages will be apparent from the description and drawings, and from the claims.

### DESCRIPTION OF DRAWINGS

FIGS. 1A-1C illustrate schematic views of one example embodiment of a mobile installer;

FIG. 2 illustrates an example array of solar energy system installation locations during operation of a mobile installer;

FIG. 3 illustrates an example method of operation of a mobile installer; and

FIG. 4 illustrates another example method of operation of a mobile installer.

### DETAILED DESCRIPTION

In some embodiments of a mobile installer according to the present disclosure, one or more components of one or more systems, such as solar energy systems, may be installed within an array of systems to, for instance, gather solar energy. Although the present disclosure describes the mobile installer in the context of solar energy system installation, the mobile installer may be utilized to install one or more components of other types of systems, such as wind energy systems and others. For example, the mobile installer may include a mobile vehicle with one or more movable racks having one or more augers and/or post installers. The mobile installer may traverse a terranean surface either according to a pre-determined set of directions to multiple solar energy system installation locations, or, dynamically according to the features of the terranean surface and/or prerequisites of the array. Once located at an installation location, the mobile installer may be adjusted (e.g., automatically or manually) to perform installation operations. In one example installation operation, a post hole may be formed in the terranean surface and a post, such as a support member for a solar energy system, may be installed. In some embodiments, the mobile installer may be directed entirely by one or more software modules executing on a computer of the mobile solar energy installer. In other embodiments, the mobile installer may be directed by a human driver and/or operator. In still other embodiments, the mobile installer may be directed by a combination of one or more software modules executing on a computer of the mobile installer and a human driver and/or operator.

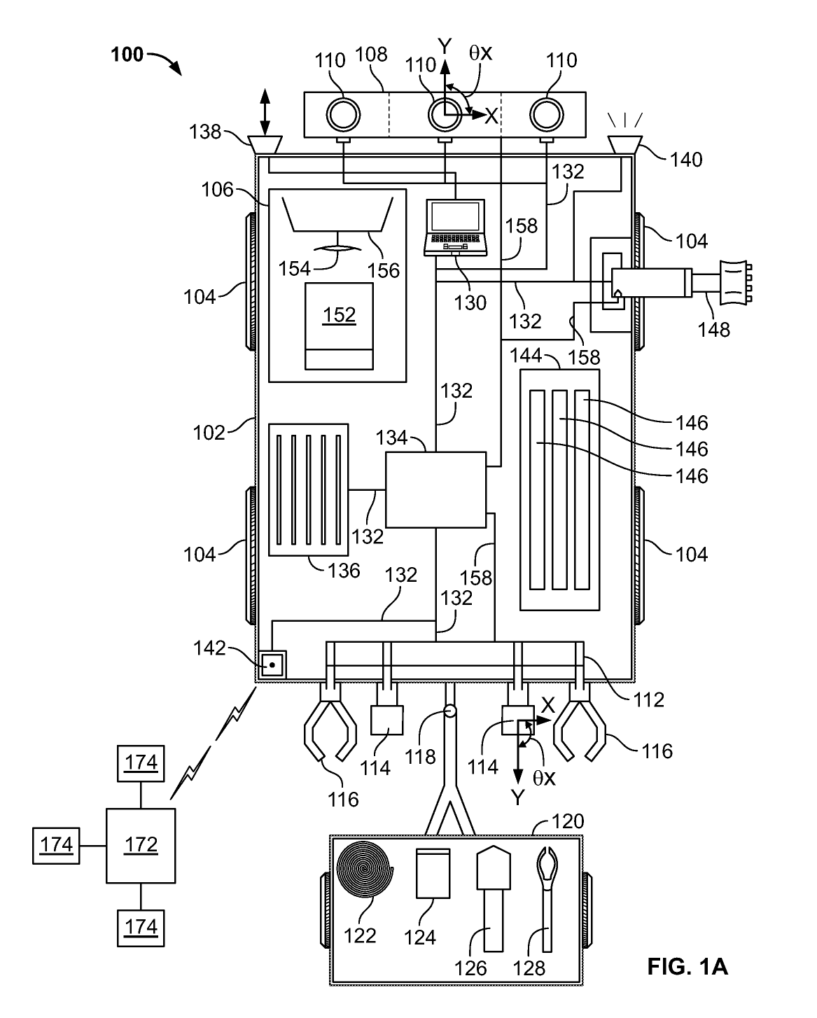

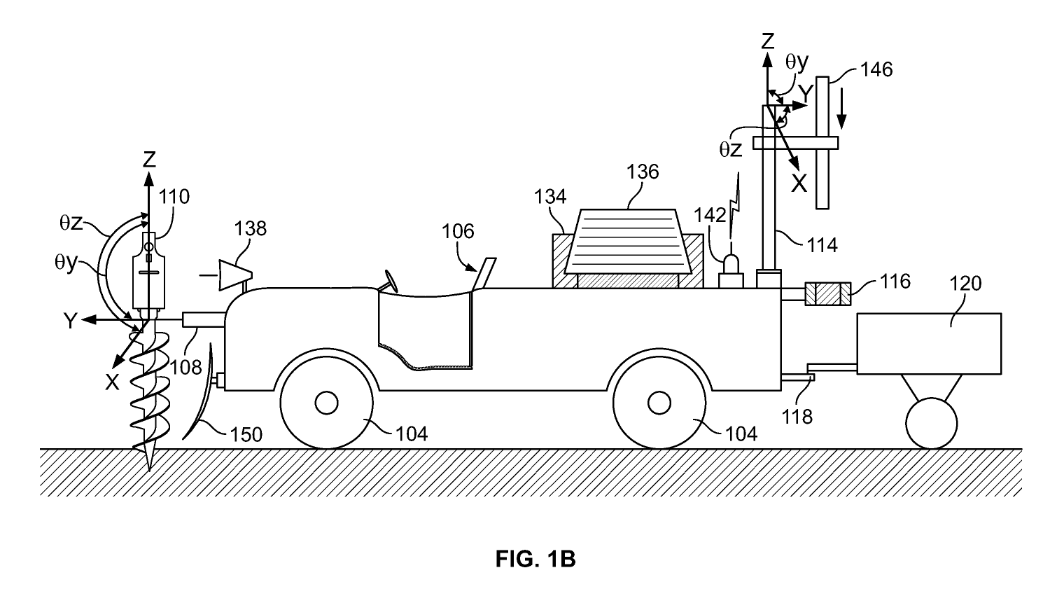

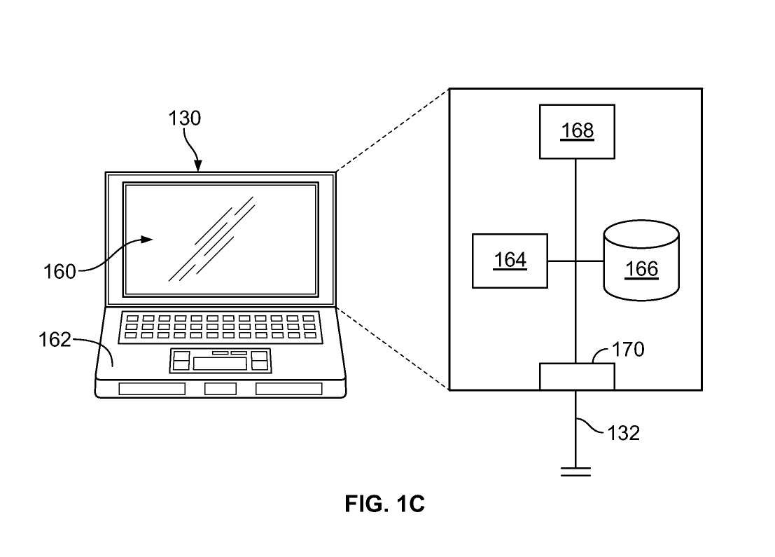

FIGS. 1A-1C illustrate schematic views of one example embodiment of a mobile solar energy system installer 100 (“mobile SES installer 100”). In some embodiments, the mobile SES installer 100 may be an automated and/or manned vehicle that is operable to install, at least partially, one or more components of one or more solar energy systems. The solar energy systems may be, for example, complete heliostats or photovoltaic (PV) systems, partial heliostats or PV systems, structural members of a solar energy system (such as a heliostat or PV system), or wiring and/or or plumbing associated with a solar energy system. As heliostats, for example, the solar energy system may track (e.g., rotate along an azimuth and/or pivot through an elevation) the Sun in order to receive and reflect solar energy from the Sun to a solar energy collector (i.e., a receiver) located remote from the heliostat. In some instances, a solar energy system may be one of many systems installed within a field or array that operate in concert to collect and/or reflect solar energy to one or more receivers. Changes in azimuth of a solar energy system refers to rotation of a solar energy member of the system (i.e., a heliostat mirror or PV cell) about a vertical, or azimuthal, axis. Changes in elevation of the solar energy system refers to changes in the angle between the direction the solar energy member is pointing and a local horizontal plane, i.e., changes in the up-down angle. A solar energy member may be mounted to a support member of a solar energy system such that rotation about the azimuthal axis and rotation (i.e., pivotal movement) about the elevational axis within desired ranges to account for tracking the Sun throughout the course of day and throughout the days of a year are facilitated.

As illustrated in FIGS. 1A-1B, the mobile SES installer 100 includes a frame 102 to which one or more wheels 104 are coupled. The mobile SES installer 100 also includes a cockpit 106, a computer 130, a power module 134, a solar energy module 136, and a material bin 144 mounted, for example, on a top surface of the frame 102. In addition, as illustrated, the mobile SES installer 100 includes a front rack 108 mounted to a front end of the frame 102, a rear rack 112 mounted to a rear end of the frame 102, and a hitch assembly 118 protruding from the rear end of the frame 102. As illustrated, the mobile SES installer 100 also includes a backhoe 148 mounted to the frame 102 and a dozer blade 150 mounted to the front end of the frame 102. Further, as illustrated, the example embodiment of the mobile SES installer 100 includes a laser finder 138, a geologic mapping sensor 140, and a communication transceiver 142.

The wheels 104, generally, facilitate movement or traversal of the mobile SES installer 100 across a terranean surface so that one or more components of solar energy systems may be installed by or with the mobile SES installer 100. Although four wheels 104 are illustrated, more or fewer wheels 104 may be coupled to the frame 102. Moreover, in alternative embodiments, other forms of traversal may be used, such as, for example, tracks or a combination of wheels and tracks, to name but one. In some embodiments, each wheel 104 may be individually controllable, so as to allow for easier traversal over uneven terrain. Further, in some embodiments, the frame 102 may be articulated, or segmented, such that one or more wheels 104 may control movement of one segment of the frame 102.

The cockpit 106 may include a seat 152, a steering wheel 154 (or other configuration of steering device, e.g., joystick), and a control console 156, such as that found in, for example, a car, a truck, or other motorized vehicle. A driver may utilize the cockpit to control movement and operation of the mobile SES installer 100 over the terranean surface to, for example, install one or more components of the solar energy system. The cockpit 106 may also include an acceleration device and brake device (e.g., pedals), as well as any additional control components used to manage movement of the mobile SES installer 100, such as, for example, gauges, dials, indicators, and otherwise. In some alternative embodiments, the SES installer 100 may not include the cockpit 106 and may, instead, be controlled remotely (e.g., by RF and/or automatically, such as by robotic control).

The front rack 108, as illustrated, is mounted to the front end of the frame 102 and supports one or more augur assemblies, and in the example shown, three auger assemblies 110. In some embodiments, each auger assembly 110 may be, for example, all or a portion of an augering system as manufactured by Ground Hog, Inc. at 1470 S. Victoria Ct., San Bernardino, Calif. 92408, USA. Each auger assembly 110 may be individually movable (e.g., pivotable) and controllable to form a post hole in the terranean surface. For instance, each auger assembly 110 may move (e.g., translate) about one or all of the x, y, and z axes illustrated in FIGS. 1A-1B. Further, each auger assembly 110 may move (e.g., pivot or rotate) in one or more of the thetaₓ, theta_{y}, and theta_{z} directions, as illustrated. Thus, the auger assemblies 110 may move, either individually or in combination, in up to six degrees of freedom.

In some embodiments, the front rack 108 may also move (e.g., translate, pivot, or rotate) in up to six degrees of freedom. For example, the front rack 108 may translate in one or more of the x, y, and z axes. Also, the front rack 108 may move (e.g., pivot or rotate) in one or more of the thetaₓ, theta_{y}, and theta_{z} directions. Upon movement of the front rack 108, one or more of the auger assemblies 110 may also move (e.g., translate or rotate). Although three auger assemblies 110 are illustrated, more or fewer auger assemblies 110 may be mounted to the front rack 108, as appropriate.

The rear rack 112, as illustrated, is mounted to the rear end of the frame 102 and supports two post installers 114 and two post clamps 116. In some embodiments, each post installer 114 may be, for example, all or a portion of a post installing system as manufactured by Post-Vibe, Inc. at #3, 4625-63 St., Red Deer, Alberta, Canada. Each post installer 114 may be individually movable (e.g., pivotable) and controllable to install a post (e.g., a support member for a solar energy system) into the terranean surface. For instance, each post installer 114 may move (e.g., translate) about one or all of the x, y, and z axes illustrated in FIGS. 1A-1B. Further, each post installer 114 may move (e.g., pivot or rotate) in one or more of the thetaₓ, theta_{y}, and theta_{z} directions, as illustrated. Thus, the post installers 114 may move, either individually or in combination, with up to six degrees of freedom.

Each post clamp 116 may hold or support one or more posts, such as posts 146 stored in the materials bin 144 on the mobile SES installer 100. While FIG. 1A illustrates the posts 146 in a particular scale with, for example, the mobile SES installer 100, the posts 146 may be longer than the installer 100, or the length of the posts 146 relative to the mobile SES installer 100 may be different than shown in this figure. Further, although illustrated as arranged lengthwise and/or horizontally disposed in the materials bin 144, the posts 146 may be stored for transport in a vertical or substantially vertical position. The posts 146, in some embodiments, may be stored in a separate container or storage area rather than the bin 144, such as the trailer 120, a rack attached to the side of the mobile SES installer 100 configured to hold the posts substantially horizontally, or other container.

In some embodiments, each post clamp 116 may move (e.g., translate) about one or all of the x, y, and z axes. Further, each post clamp 116 may move (e.g., pivot or rotate) in one or more of the thetaₓ, theta_{y}, and theta_{z} directions. Thus, the post clamps 116 may move, either individually or in combination, in up to six degrees of freedom. For example, in some embodiments, movement in up to six degrees of freedom may allow the post clamp 116 to obtain a post 146 from the material bin 144 and hold the post 146 in a particular position until the post installer 114 is ready to install the post 146. For instance, in some aspects, one or more post clamps 116 may be moving to obtain and position one or more posts 146 simultaneously with one or more post installers 114 installing previously obtained posts 146. Further, in some embodiments, one or more post clamps 116 may be integral with or combined with one or more post installers 114.

In some embodiments, the rear rack 112 may also move (e.g., translate, pivot, or rotate) in up to six degrees of freedom. For example, the rear rack 112 may translate in one or more of the x, y, and z axes. Also, the rear rack 112 may move (e.g., pivot or rotate) in one or more of the thetaₓ, theta_{y}, and theta_{z} directions. Upon movement of the rear rack 112, one or more of the post installers 114 and/or post clamps 116 may also move (e.g., translate or rotate). Although two post installers 114 and two post clamps 116 are illustrated, more or fewer post installers 114 and post clamps 116 may be mounted to the rear rack 112, as appropriate.

In some embodiments, the auger assemblies 110, the post clamps 116, and/or the post installers 114 may be arranged on a single side of the mobile SES installer 100, such as, for example, the front end of the frame 102. In such embodiments, for example, a particular post 146 may be obtained from the materials bin 144, held in position, and installed in a post hole previously formed by an auger assembly 110. Further, such actions may occur for more than one post 146 at the same time or substantially in parallel. As described above, the front rack 108 and rear rack 112 may independently move (e.g., translate and/or rotate) in several degrees of freedom individual, as may the auger assemblies 110, post clamps 116, and post installers 114.

In another example embodiment, one or more auger assemblies 110, post clamps 116, and/or post installers 114 may be arranged on the mobile SES installer 100 at a middle portion of the frame 102 rather than at the ends of the frame 102, as illustrated. Moreover, one or both of the racks 108 and 112 may be arranged at the middle portion of the frame 102 rather than at the ends of the frame 102, as illustrated. For instance, the racks 108/112 and/or individual auger assemblies 110, post clamps 116, and/or post installers 114 may be mounted on the frame 102 proximate a center of the frame 102 and be arranged to perform operations from the sides of the frame 102.

Accordingly, each rack 108 and 112, as well as each component coupled to the racks 108 and 112, may independently move to perform simultaneous (or substantially simultaneous) operations to install multiple posts 146. Such installations may occur, for example, at a single macro-position (e.g., with the mobile SES installer 100 substantially stationary) but at independent micro-positions (e.g., independent and individual installation locations). Thus, in some embodiments when one or more auger assemblies 110, post clamps 116, and post installers 114 are mounted on the same area and/or side of the mobile SES installer 100, multiple installation operations using one or more of these components may be occurring simultaneously.

Further, even if one or more of the auger assemblies 110, post clamps 116, and post installers 114 are mounted on different areas and/or sides of the mobile SES installer 100, multiple installation operations may be occurring simultaneously. For example, in the illustrated embodiment, one or more of the auger assemblies 110 perform operations to form one or more post holes (i.e., in front of the mobile SES installer 100) while one or more of the post installers 114 perform operations to install posts 146 into previously formed post holes (i.e., behind the mobile SES installer 100). The reaches of the front rack 108 and the rear rack 112 (e.g., in front of and behind the mobile SES installer 100 respectively) and the dimensions of the mobile SES installer 100 can be such that multiple micro-positions can be worked on simultaneously while the mobile SES installer 100 is parked at a single macro-position. For example, in some embodiments, one or more solar energy systems (or solar energy system components) may be installed while the SES installer 100 is in motion; while the SES installer 100 is in motion and one or more components of the installer 100 are in motion to arrive at one or more micro-positions; and/or while the SES installer 100 is stationary but one or more components of the installer 100 are in motion to arrive at one or more micro-positions.

The hitch assembly 118 provides for a point of coupling for a trailer or other towed apparatus, such as the illustrated trailer 120, to the frame 102. As shown, the trailer 120 may be towed by the mobile SES installer 100 and may carry one or more components or materials for installation assistance of a solar energy system. For example, as illustrated, the trailer 120 may carry a length of cable 122, cement or concrete 124, a shovel 126, and a posthole digger 128. Of course, additional components or materials used for installing or partially installing a solar energy system may be contained in the trailer 120.

The mobile SES installer 130, as illustrated, also includes a computer 130, which is communicably coupled through a data link 132 to one or more components of the mobile SES installer 100, such as, for example, the front rack 108 and one or more auger assemblies 110; the rear rack 112 and one or more post installers 114 and post clamps 116; the power module 134; the solar power module 136; the backhoe 148; the laser finder 138; the geologic mapping sensor 140; and the communication module 142.

Referring to FIG. 1C, the computer 130 includes a processor 164, which executes a solar energy system installer module 168, a memory 166, a network interface 170, a graphical user interface (GUI) 160, and an input peripheral device 162 (e.g., a keyboard as illustrated, or other input device). The processor 164 executes instructions and manipulates data to perform the operations of the computer 130. The processor 164 is, for example, a central processing unit (CPU), a blade, an application specific integrated circuit (ASIC), or a field-programmable gate array (FPGA). Although FIG. 1C illustrates a single processor 164 in computer 130, multiple processors 164 may be used according to particular needs and reference to processor 164 is meant to include multiple processors where applicable. In the illustrated embodiment, processor 164 executes the solar energy system installer module 168.

At a high-level, the solar energy system installer module 168 can be a software module that receives, generates, transforms, transmits, and/or stores data related to the mobile SES installer 100. More specifically, the solar energy system installer module 168 is an application, program, module, process, or other software that receives data from the mobile SES installer 100; transforms such data and presents all or a portion of such data to one or more users; and receives commands or instructions from such users in order to control and/or manipulate one or more components of the mobile SES installer 100. Regardless of the particular implementation, “software” may include software, firmware, wired or programmed hardware, or any combination thereof as appropriate. Indeed, solar energy system installer module 168 may be written or described in any appropriate computer language including C, C++, Java, Visual Basic, assembler, Perl, any suitable version of 4GL, as well as others. For example, solar energy system installer module 168 may be a composite application, portions of which may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. It will be understood that while solar energy system installer module 168 is illustrated in FIG. 1C as a single module, solar energy system installer module 168 may include numerous other sub-modules or may instead be a single multi-tasked module that implements the various features and functionality through various objects, methods, or other processes. Further, while illustrated as internal to computer 130, one or more processes associated with solar energy system installer module 168 may be stored, referenced, or executed remotely. For example, a portion of solar energy system installer module 168 may be a web service that is remotely called, while another portion of solar energy system installer module 168 may be an interface object bundled for processing at, for example, one or more clients or servers located remotely from the mobile SES installer 100. Moreover, solar energy system installer module 168 may be a child or sub-module of another software module or enterprise application (not illustrated) without departing from the scope of this disclosure.

Memory 166, generally, stores data received from the mobile SES installer 100, and requests or instructions received from one or more users, among other data. In any event, however, memory 166 may store any appropriate information associated with the mobile SES installer 100 and/or the remote station 172. Memory 166 may, in some embodiments, include any memory or database module and may take the form of volatile or non-volatile memory including, without limitation, magnetic media, optical media, random access memory (RAM), read-only memory (ROM), removable media, or any other suitable local or remote memory component. Memory 166 may also include, along with the aforementioned solar energy system installation-related data, any other appropriate data such as VPN applications or services, firewall policies, a security or access log, print or other reporting files, HTML files or templates, data classes or object interfaces, child software applications or sub-systems, and others. Although illustrated as a single memory 166, reference to memory 166 includes reference to any number of memories or portions of memories, as appropriate.

The computer 130 communicates with one or more components of the mobile SES installer 100 via a network interface 170. In certain embodiments, computer 130 receives data from internal or external senders through interface 170 for storage in memory 166 and/or processing by processor 164. Generally, interface 170 includes logic encoded in software and/or hardware in a suitable combination and operable to communicate through the data link 132. More specifically, interface 170 may include software supporting one or more communications protocols associated with communication networks or hardware operable to communicate physical signals.

Returning now to FIG. 1A, the mobile SES installer 100 may communicate with a remote station 172 via the communication module 142, which is communicably coupled to the computer 130. The remote station 172 may include one or more clients 174 that may be used to manage, monitor, or control operation of the mobile SES installer 100 during installation of one or more components of one or more solar energy systems. As used herein, a “client” is a computing device operable to connect or communicate with computer 130 using a communication link. At a high level, each client 174 comprises an electronic computing device operable to receive, transmit, process, and store any appropriate data associated with the mobile SES installer 100 and/or the remote station 172. A client 174 typically includes local memory or may be coupled with some relatively remote or distributed memory that may be quickly accessed. Moreover, for ease of illustration, while each client 174 may be used by one user, many users may use one computer or one user may use multiple computers. For example, each client 174 may encompass a personal computer, touch screen terminal, workstation, network computer, kiosk, wireless data port, smart phone, personal data assistant (PDA), one or more processors within these or other devices, or any other suitable processing device that may be operated by a user. In another example, clients 174 may include a laptop that includes an input device, such as a keypad, touch screen, mouse, or other device that can accept information, and an output device that conveys information associated with the operation of computer 130 or clients 174, including digital data and/or visual information. Both the input device and output device may include fixed or removable storage media such as a magnetic computer disk, CD-ROM, or other suitable media to both receive input from and provide output to users of clients 174.

The communication module 142, as illustrated, is attached or coupled to the computer 130 via the data link 132. Alternatively, the communications module 142 may be integral with the computer 130. In the illustrated embodiment, the communication module 142 may allow for two-way audio and/or data communication between a user at the mobile SES installer 100 and another person located remotely from the mobile SES installer 100. For example, the communication module 142 may be a cellular phone cradle, whereby a wireless communication device (e.g., cell phone, personal e-mail device, smart phone, or otherwise) may be charged and stored. Alternatively, the communication module 142 maybe any other appropriate device, such as a satellite phone, CB radio, or two-way walkie-talkie, which would allow audio communication to and from the mobile SES installer 100.

In some embodiments, the communication module 142 may be a mobile user device that can receive specific data. For example, the computer 130 and/or driver of the mobile SES installer 100 may receive data (e.g., instructions, coordinates, directions, geolocations, and other data) via the communication module 142 and the computer 130. In one example, directional data may be transmitted through the communication module 142 for display on the computer 130, thereby guiding the driver of the mobile SES installer 100 to subsequent installation locations of one or more solar energy system components. Such directions may be determined, for example, by global positioning satellite (GPS) techniques, such as absolute GPS, differential GPS, or triangulation. Such directions may be determined by, for example, the solar energy system installer module 168, similar or different software and/or hardware located remotely from the mobile SES installer 100, or the driver with reference to a standalone GPS module mounted on the mobile SES installer 100 (not shown).

The computer 130 may communicate to remote computers, clients, or other devices through one or more networks via, for example, Internet Protocol (IP) packets, Frame Relay frames, Asynchronous Transfer Mode (ATM) cells, voice, video, data, and other suitable information between network addresses. Such networks may include one or more local area networks (LANs), radio access networks (RANs), metropolitan area networks (MANs), wide area networks (WANs), all or a portion of the global computer network known as the Internet, and/or any other communication system or systems at one or more locations.

With reference to FIGS. 1A-1B, the power module 134 may be mounted in or on the frame 102 and may be communicably coupled to the computer 130 and coupled to, for example, one or more of the auger assemblies 110, one or more post installers 114, one or more post clamps 116, and the backhoe 148 via power link 158. As illustrated, the power module 134 may provide power, such as hydraulic power, to one or more of the auger assemblies 110, one or more post installers 114, one or more post clamps 116, and the backhoe 148. The hydraulic power may be generated by the power module 134 or, in other embodiments, by an engine of the mobile SES installer 100. In still other embodiments, the power module 134 may include a power generator for the mobile SES installer 100 (e.g., an internal combustion engine including gas tank etc., diesel engine, electric motor, hybrid power system including a combination of engine and motor, or other power generator) as well as a power converter to supply the hydraulic power to one or more of the auger assemblies 110, one or more post installers 114, one or more post clamps 116, and the backhoe 148. Further, the solar energy module 136 may provide power (e.g., electrical power) to the power module 134 to power other components of the mobile SES installer 100 (e.g., the communication module 142, the laser finder 138, and the geologic mapping sensor 140). In some embodiments, the solar energy module 136 may supplement power generated by the power module 134.

The laser finder 138 and the geologic mapping sensor 140 are communicably coupled to the computer 130. The laser finder 138 may, for example, determine a distance from the mobile SES installer 100 to a particular location, such as, for example, a geologic formation (e.g., hill, mountain, change in elevation, rock outcropping, etc.) as well as other formations. Such data may be used, for example, to determine or help determine optimal installation locations for one or more components of a solar energy system to be installed by the mobile SES installer 100. The geologic mapping sensor 140 may, in some embodiments, provide for “look ahead” information regarding obstacles and/or structures located ahead of the mobile SES installer 100 and at least partially sunken into the terranean surface. For example, the geologic mapping sensor 140 may provide two-or three-dimensional data to the computer 130 to be displayed to a human operator, e.g., the driver of the mobile SES installer 100 or a person located remote from the mobile SES installer 100, showing, for example, positions of rocks, roots, and/or other underground structures. Such underground structures may, for example, interfere with installation of one or more components of a solar energy system, such as a post, or support member. In some embodiments, the geologic mapping sensor 140 may use seismic techniques to gather data regarding the underground structures (e.g., size, distance from the mobile SES installer 100, density, etc.). Alternatively, other techniques, such as sonar, radar (e.g., ground penetrating radar), or infrared, may be used by the geologic mapping sensor 140.

The material bin 144 is configured to contain and/or enclose a variety of materials and/or components for installing one or more solar energy systems. As illustrated, for example, the material bin 144 may contain one or more posts 146. The posts 146, in some embodiments, may be a support member for a solar energy system, such as a heliostat. The post 146, when installed, may be substantially vertical in orientation and mounted orthogonal to the terranean surface. The post 146, in some embodiments, may be a wooden post, such as a cylindrical wooden post treated for exposure to varying environmental conditions (e.g., moisture, heat, and otherwise). Alternatively, the post 146 may be any suitable material, such as stainless steel, painted ferrous steel, formed concrete, or otherwise, that may be secured in a substantially vertical position and support a solar energy member (e.g., a heliostat mirror) of a solar energy system. In some embodiments, the posts 146 may include a support member with additional integral, or attached, features, such as, for example, a footer, a solar energy member (e.g., heliostat mirror or PV panel), a cable(s), an actuator(s), a motor(s), and other components used to mount and/or install a solar energy system. Thus, installation of the post 146 may also include installation of all or a substantial portion of a solar energy system.

As illustrated in FIGS. 1A-1B, the mobile SES installer 100 includes a backhoe 148 mounted on one side of the frame 102, as well as a dozer blade 150 mounted on the front end of the frame 102. Typically, the backhoe 148 and dozer blade 150 may be operated (e.g., by a driver of the mobile SES installer 100) to assist in installation and/or pre-installation work of one or more solar energy systems. For example, the dozer blade 150 may be used to grade uneven terrain and/or remove geologic (or other) obstacles at or adjacent an installation location of a solar energy system. The backhoe 148 may be operated to, for example, form a trench for the installation of one or more components of a solar energy system. For example, the backhoe 148 may be operated to form a trench for installing wiring, conduit, piping, or a combination thereof for one or more solar energy systems. The wiring, for example, may communicably couple the one or more solar energy systems together for the transmission and/or receipt of signals, commands, and/or electronic data. Further, the backhoe 148 may be operated to remove loose terrain or other obstacles. In some embodiments, one or both of the dozer blade 150 and backhoe 148 may receive power (e.g., hydraulic power) from the power module 134.

In operation, the mobile SES installer 100 may traverse (e.g., be driven or directed) a terranean surface to install or help install one or more components of one or more solar energy systems, such as heliostats or PV cells. For example, the mobile SES installer 100 may be driven or directed to a first macro position at which a solar energy system is to be installed. The macro position may be near, and more particularly, within a predetermined distance of (e.g., between a 5 and 10 feet diameter area) an optimum installation location of the solar energy system. The optimum installation location may be determined according to, for example, a distance from a solar energy receiver; an elevation of the terranean surface; geologic structures (e.g., rocks, faults, etc.); human structures; and other considerations. Once at the macro position, the mobile SES installer 100 may be operated (e.g., manually or automatically) to adjust to a micro position. For example, one or more of the front rack 108 and/or auger assemblies 110 may move (e.g., translate and/or rotate) so that at least one auger assembly 110 is positioned at or near the optimum installation location. The micro position may be nearer, and in some embodiments much nearer, the optimum installation location compared to the macro position. The auger assembly 110 positioned at the micro position may then be operated to form a hole in the terranean surface. Once complete, the mobile SES installer 100 may be positioned such that one of the post installers 114 is at the micro position. A post 146 may then be installed in the hole and completion of the installation of the post 146 (i.e., a support member of a solar energy system) may be accomplished.

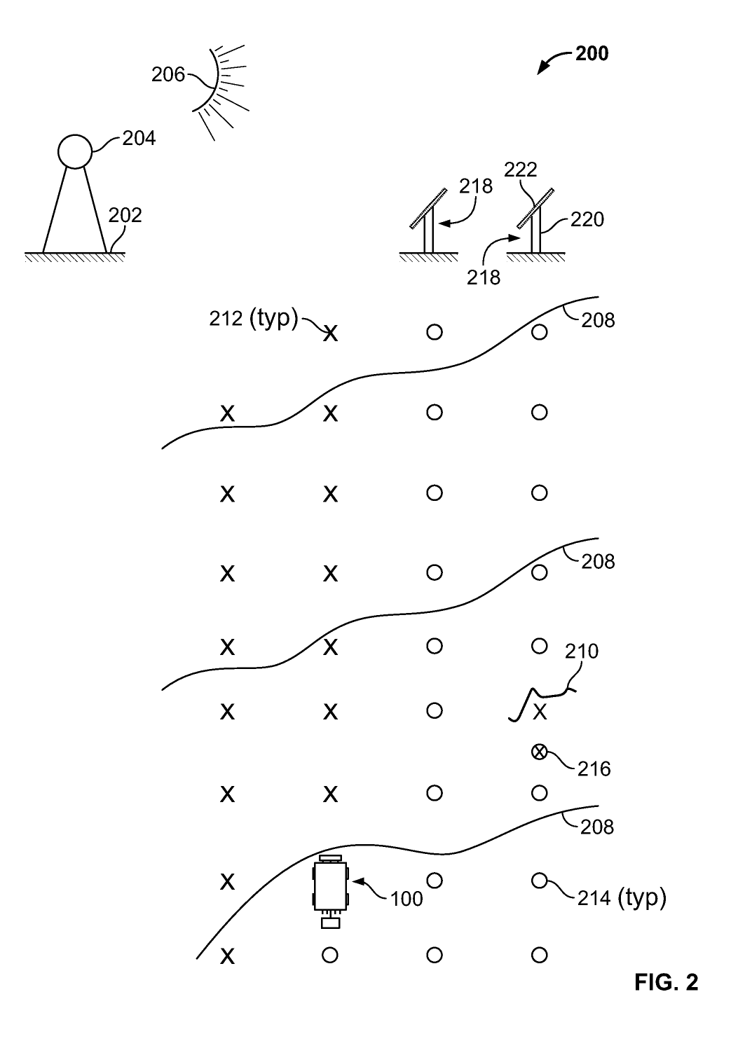

In some embodiments, the foregoing operation of the mobile SES installer 100 (and other operations) may be completely automated by, for example, the solar energy system installer module 168 on the computer 130. Thus, the solar energy system installer module 168 may direct all operations of the mobile SES installer 100. In alternative embodiments, another software module may be executed, for example remotely from the mobile SES installer 100 at the remote station 170, to direct operations of the mobile SES installer 100. In other embodiments, direction of the mobile SES installer 100 may be by a combination of two or more of the solar energy system installer module 168 on the computer 130, a remote software module, and a driver of the mobile SES installer 100. Further description of example operations of the mobile SES installer 100 are described with reference to FIGS. 2-4.

In some example operations, the mobile SES installer 100 may be automated (e.g., all or predominantly). For example, the mobile SES installer 100, and more particularly the solar energy system installer module 168 or other software module, may receive input data and use this data to calculate one or more macro positions and/or micro positions as installation locations for one or more solar energy systems. For example, the input data may include one or more of the following: a location (current or future) of a solar energy receiver; a minimum distance between solar energy systems (exact or approximate); a maximum distance between solar energy systems (exact or approximate); a minimum distance of a solar energy member mounted on a support member of the solar energy system above a terranean surface (exact or approximate); a maximum distance of a solar energy member mounted on a support member of the solar energy system above a terranean surface (exact or approximate); a total number of solar energy systems to be installed; a total area of a terranean surface for installation of the total number of solar energy systems; a maximum area (e.g., radius of a circular area) of a macro position for installation of a solar energy system; a minimum area (e.g., radius of a circular area) of a macro position for installation of a solar energy system; a maximum area (e.g., radius of a circular area) of a micro position for installation of a solar energy system; a minimum area (e.g., radius of a circular area) of a micro position for installation of a solar energy system; one or more GPS locations of corresponding solar energy system installation locations (exact or approximate); one or more GPS locations defining a maximum area of a terranean surface on which the total number of solar energy systems are to be installed; and other data describing and/or defining the terranean surface on which one or more solar energy systems are to be installed (e.g., geologic data, elevational data, and otherwise).

The mobile SES installer 100 may receive and/or generate the above-described data and calculate installation locations of solar energy systems based at least in part on such data. In some embodiments, the mobile SES installer 100 may determine each macro position and/or micro position for the installation locations prior to the installer 100 beginning the installation process. For example, each macro and/or micro position may be predetermined prior to the installation process such that the mobile SES installer 100 traverses the terranean surface to install one or more solar energy systems without substantial processing of any other data. In other embodiments, the mobile SES installer 100 may have predetermined the macro and/or micro positions of the proposed installation locations, but can also dynamically adjusts one or more of such positions based on data received during the installation process. For example, the mobile SES installer 100 may receive information (in addition to such information described above) regarding possible obstacles and/or elevational fluctuations of the terranean surface prior to arriving at one or more macro and/or micro positions. Such information may be received and/or generated, for example, by the laser finder 138 and the geologic mapping sensor 140. Thus, the mobile SES installer 100 may adjust one or more of a macro or micro position of an installation location based on the dynamically determined information, such as the geologic and/or elevational data. As one example, if a solar energy system support member (e.g., a post) was to be installed on top of a rock underneath the terranean surface, such that the shadowing of that solar energy system onto neighboring and/or adjacent systems would affect overall performance of an array of solar energy systems, the remaining positions of the neighboring and/or adjacent solar energy systems (or other systems) might be adjusted (e.g., moved) to account for the performance degradation.

FIG. 2 illustrates an example array 200 of solar energy system installation locations during operation of a mobile SES installer, such as the mobile SES installer 100. As illustrated, the array 200 includes multiple proposed installation locations 212 and completed installation locations 214 arranged around a solar energy receiver 204 mounted on a terranean surface 202. The proposed and completed installation locations are at different elevations 208 on the terranean surface 202. In some embodiments, such as those having solar energy systems as heliostats installed at the locations 212 and 214, solar energy may be received from the Sun 206 at the solar energy systems and reflected toward the solar energy receiver 204. In alternative embodiments, such as those having solar energy systems as PV cells, the solar energy receiver 204 is not present.

As illustrated, the mobile SES installer 100 may traverse through the array 200 and install one or more components of one or more solar energy systems, such as, for example, a support member of each solar energy system. Alternatively, complete solar energy systems (including, for example, a solar energy member and support structure, such as cables, foundation, etc.) may be installed by or using the mobile SES installer 100. In some embodiments, the complete solar energy systems may be transported in the trailer 120 or another vehicle to each of the installation sites. For example, the solar energy systems may have been previously deposited at an installation site (e.g., at a macro-position) and ready to be picked up and installed at a specific installation location (e.g., at a micro-position). As illustrated, array 200 includes solar energy systems 218 including support members 220 and solar energy members 222. In some embodiments, the solar energy systems 218 may be heliostats, where the support member 220 is a substantially vertical post and the solar energy member 222 is a heliostat mirror.

In order to install at least a part of a solar energy system 218 at each location 212 and 214, the mobile SES installer 100 may be directed to one of the proposed installation locations 212. As described above, the mobile SES installer 100 may install or be used to install all or a portion of the solar energy system 218, such as, for example, a post 146. Once all or a portion of the solar energy system 218 is installed at the proposed installation location 212, the mobile SES installer 100 may traverse (e.g. be automatically directed or driven) to the next proposed installation location 212. Further, once all or a portion of the solar energy system 218 is installed at the proposed installation location 212, that location 212 may be designated a completed installation location 214. The mobile SES installer 100 may continue in such a fashion until all (or most) of the proposed installation locations 212 become completed installation locations 214.

As illustrated, in some instances, a geologic obstruction 210 (e.g., a rock, ledge, fault, etc.) or other obstruction (e.g., tree or other botanical) may be located at or near a proposed installation location 212. In some cases, the obstruction 210 may be located all or partially underneath the terranean surface 206. In some embodiments, as the mobile SES installer 100 approaches the proposed installation location 212, the mobile SES installer 100 may detect the geologic obstruction 210. For example, the mobile SES installer 100 may detect the geologic obstruction 210 with the geologic mapping sensor 140 and display to a driver of the mobile SES installer 100 (or a remote operator) a two or three-dimensional model of the terranean surface 206 including the geologic obstruction 210. Alternatively, the two or three-dimensional model of the terranean surface 206 may have been previously generated and transmitted (or saved in memory of the computer 130) to the mobile SES installer 100. In any event, the mobile SES installer 100 may determine and/or be directed to an alternate proposed installation location 216. At the alternate proposed installation location 216, the mobile SES installer 100 may install all or part of a solar energy system 218.

In some embodiments, a post of the solar energy system 218 may be installed to a particular height. For instance, in some embodiments, each solar energy member (e.g., a heliostat mirror) of a plurality of solar energy systems 218 installed in the array 200 may be installed at substantially the same elevational location above the terranean surface 206. Further, in some embodiments, each solar energy member (e.g., a heliostat mirror) of a plurality of solar energy systems 218 installed in the array 200 may be installed at substantially the same elevational location above sea level, rather than above the terranean surface. In conventional installations or other installations using the mobile SES installer 100, the terranean surface 206 may be first graded and/or leveled prior to installation of any solar energy systems 218 so that the solar energy members are at substantially identical heights above the surface 206. For instance, on a graded and/or level surface, all support members (e.g., posts) of the solar energy systems 218 can be installed to the same depth and have the same height, thus helping ensure that the solar energy members are at the same height above the surface 206. As another example, to optimize the optics of an array of solar energy systems 218, one or a group of the systems 218 may be installed such that the solar energy members (i.e., heliostat mirror or PV cell) are positioned at various heights. For example, a gentle parabolic elevation relative to, for example, the solar energy receiver 204, may be beneficial. In such an example, the solar energy members of solar energy systems 218 installed in rows closest to the receiver 204 may be at a lower overall elevation as compared to rows installed furthest from the receiver 204.

In some embodiments, however, the mobile SES installer 100 may install one or more solar energy systems 218 prior to, or without, any grading and/or leveling of the terranean surface 206 while still ensuring that the solar energy members are at substantially the same height above the surface 206. For example, the mobile SES installer 100 may detect changes in elevation of the terranean surface 206 when traversing the surface 206 to install one or more support members of the solar energy systems 218. For instance, the laser finder 138 and/or the geologic mapping sensor 140 may detect (all or partially) elevational changes of the terranean surface 206 and adjust a depth of a post hole formed by, for example, the auger assembly 110, so that the installed height of a solar energy member is correct. As an example, a post hole being formed on a mounded region (e.g., a slight hill and/or a slightly higher elevation than surrounding areas of the terranean surface 206) may be formed to a greater depth to account for the “mound.” Accordingly, installation of the support member in the post hole may ensure that a top of the support member and/or location of a solar energy member on the support member may be consistent with the tops of all the other support members and/or consistent with the solar energy member locations of all other solar energy systems.

In some embodiments, the SES installer 100 may sense an elevation (e.g., above the terranean surface, above sea level, or above another surface), such as, for example, via a laser level system (e.g., laser sensor 138). Alternatively, or in addition, a laser level system may be positioned remotely from the SES installer 100 and may send one or more signals indicative of elevations (e.g., elevations of installed solar energy systems) to the installer 100. Further, a remotely installed laser level system may emit a signal (e.g., a spinning level laser light) that the SES installer 100 receives and reacts to. For example, a post installer 114 installing a support post (or other component) into and/or at the terranean surface) may receive a signal indicative of an elevation of a top end of the post (e.g., relative to sea level, the terranean surface, or other location). In response to the signal, the post installer 114 may, for example, continue installing the post (e.g., deeper into the terranean surface) or cease its operation.

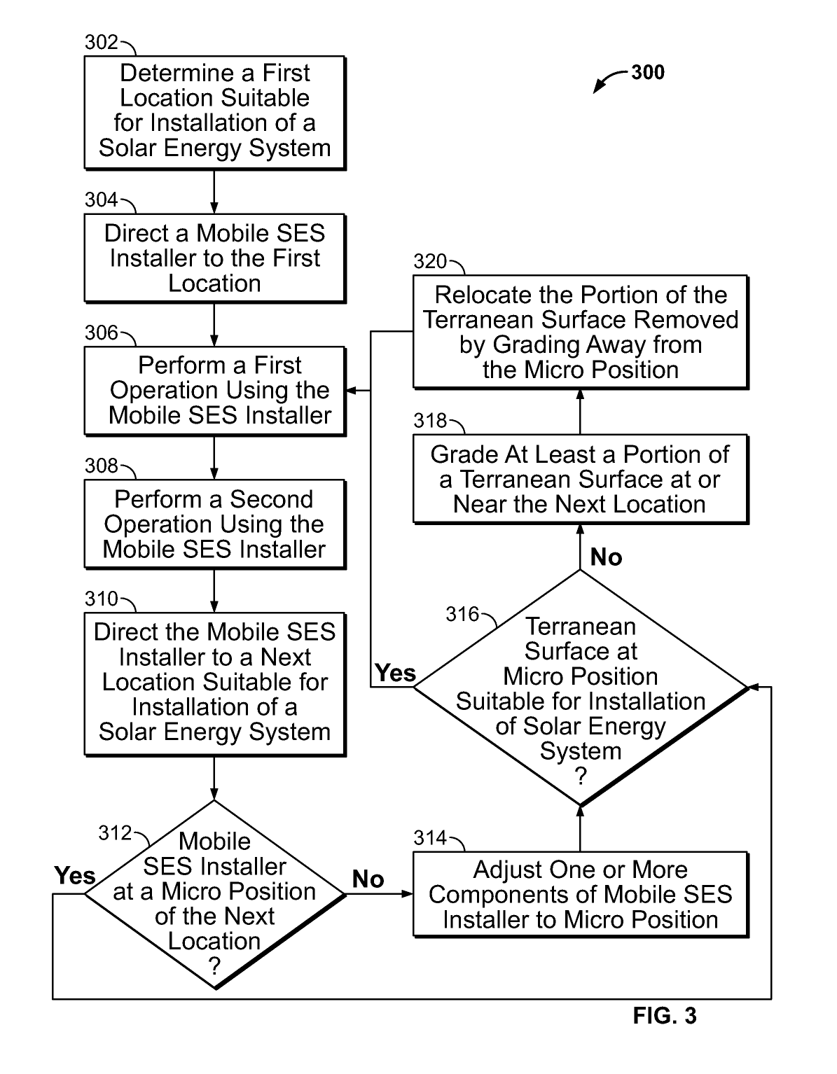

FIG. 3 illustrates an example method 300 of operation of a mobile SES installer, such as the mobile SES installer 100 illustrated in FIGS. 1A-1C. Method 300 may begin at step 302, when a first location suitable for installation of a solar energy system is determined. For example, the first location may be among several proposed locations, such as the locations 212 illustrated in FIG. 2. Further, the first location may be determined, for example, by a driver of the mobile SES installer 100, the solar energy system installer module 168 on the computer 130; other software or algorithms located remotely from the mobile SES installer 100; and/or any combination of the preceding. Next, at step 304, the mobile SES installer 100 is directed (e.g., driven or automatically directed without human intervention) to the first location. In some cases, the first location is determined prior to, and sometimes substantially prior to, any direction of the mobile SES installer 100 to the first location. In other cases, the first location may be dynamically determined, for example, while the mobile SES installer 100 is being directed towards the first location. For example, the first location may be dynamically determined according to a terrain over which the mobile SES installer 100 is being directed, a location (or future site) of a solar energy receiver, or other criteria.

Next, at step 306, the mobile SES installer 100 is used to perform a first operation. The first operation, for instance, could be an augering operation to form a hole in the terranean surface. However, many other operations (e.g., post installation, grading, removal of excess earth, and otherwise) are possible as described above. The mobile SES installer 100 next is used to perform a second operation at step 308. The second operation, for example, could be a post installation operation using one or more of the post installers 114.

In some embodiments, as described above, the first and second operations may be performed simultaneously or substantially simultaneously. For example, multiple auger assemblies may form corresponding post holes substantially simultaneously. As another example, post holes may be formed substantially simultaneous to the installation of support members in previously formed post holes. In such embodiments, the mobile SES installer 100 may traverse a certain distance (e.g., move forward to position a particular rack at a micro-position) between the first and second operations. In other embodiments, both of the first and second operations (and other operations) may be performed while the mobile SES installer 100 is stationary. In addition, there may be multiple SES installers 100 working in parallel and/or in series to install multiple solar energy systems.

At step 310, the mobile SES installer 100 is directed to a next location suitable for installation of a second solar energy system (e.g., all or partially). At step 312, a determination is made whether the mobile SES installer 100 is at a micro position at the next installation location. For example, the next location may have been determined or pre-determined (e.g., by GPS, ground penetrating radar, or other techniques) with a macro position of approximately a 5-foot to 10-foot diameter area and with a micro position of approximately a 1-foot to 3-foot diameter area within the macro position. In other embodiments, the next location may have been determined or pre-determined with a macro position of approximately a 1-foot to 3-foot diameter area and with a micro position of approximately a 0.01-foot to 3-foot diameter area within the macro position.

If the mobile SES installer 100 is not at the micro position (but is within the macro position) of the next location, one or more components of the mobile SES installer 100 may be adjusted at step 314 to adjust the mobile SES installer 100 to the micro position. For example, the front rack 208 and/or one of more auger assemblies 210 may be moved (e.g., translated or rotated in up to six degrees of freedom) in order for the mobile SES installer 100 (or a component of the mobile SES installer 100 such as one of the auger assemblies 210) to be at the micro position.

Once the mobile SES installer 100 is at the micro position of the next location (i.e., a second or subsequent location), then a determination is made whether an area of the terranean surface at the next location (e.g., at the micro position of the next location) is suitable for installation of a solar energy system at step 316. Of course, the determination of whether an area of the terranean surface at the next location (e.g., at the micro position of the next location) is suitable for installation of a solar energy system may have previously occurred, such as, for example, prior to the installation of any solar energy system. If the surface is not suitable, then at least a portion of the terranean surface at or near the next location is graded at step 318. For example, the portion may be graded by the dozer blade 150 on the mobile SES installer 100. Next, the portion of the terranean surface removed by grading away from the micro position is removed at step 320. Once the terranean surface at the next location is suitable for installation of the solar energy system (completely or partially) using the mobile SES installer 100, at step 306, the mobile SES installer 100 is used to perform a first operation at the next location. The mobile SES installer 100 next is used to perform a second operation at the next location at step 308, and so on.

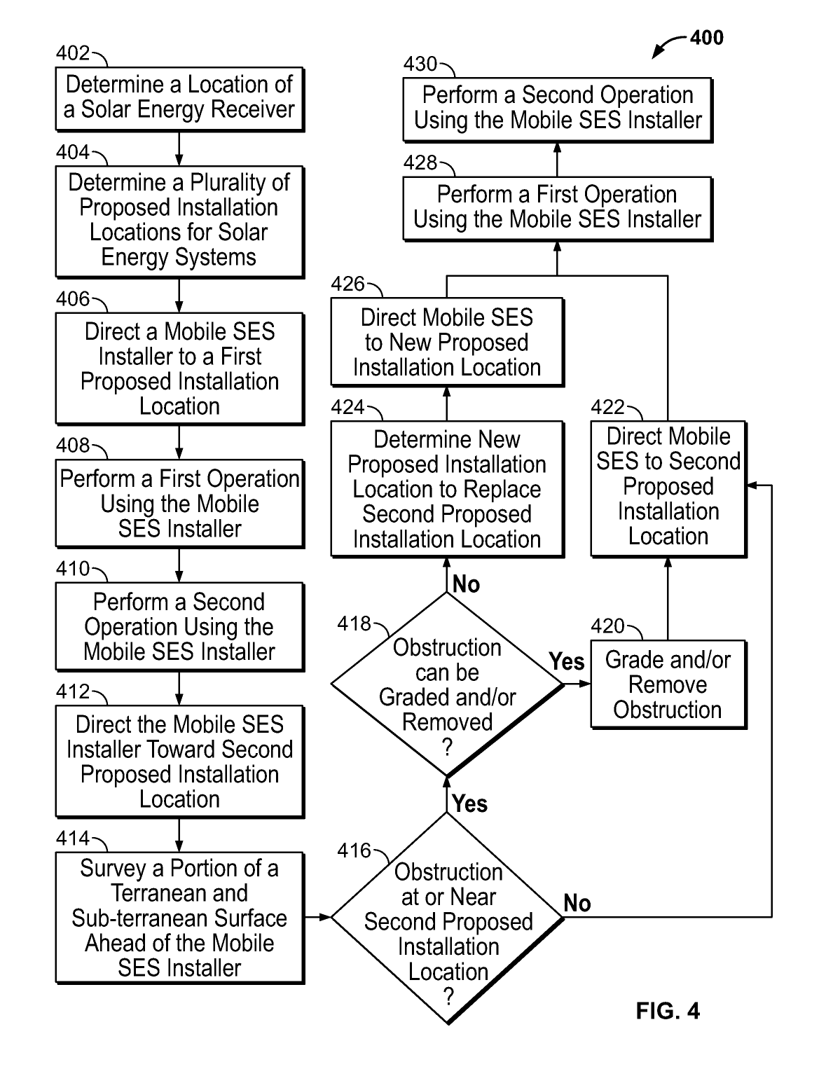

FIG. 4 illustrates another example method 400 of operation of a mobile SES installer, such as the mobile SES installer 100 illustrated in FIGS. 1A-1C. In some embodiments, for example, method 400 may be used to install one or more heliostat systems in an array, such as the array 200. Method 400 may begin at step 402, when a location suitable for installation of a solar energy receiver is determined. Next at step 404, a plurality of proposed installation locations for solar energy systems are determined. The plurality of proposed locations may be determined, for example, by a driver of the mobile SES installer 100, the solar energy system installer module 168 on the computer 130; other software or algorithms located remotely from the mobile SES installer 100; and/or any combination of the preceding. The locations may be determined according to, for example, the terrain of the area of the array, the location (or future site) of the solar energy receiver, and other considerations. Further, the plurality of locations may be determined prior to installation of any solar energy systems in the array. Alternatively, each of the plurality of proposed locations may be dynamically determined in sequential order (or other order) during installation of the solar energy systems in the array.

At step 406, the mobile SES installer 100 is directed to a first proposed installation location. At step 408, the mobile SES installer 100 is used to perform a first operation at the first location. The mobile SES installer 100 next is used to perform a second operation at the first location at step 410. The mobile SES installer 100 is next, at step 412, directed towards a second proposed installation location.

During traversal of the terranean surface towards the second proposed installation location, the mobile SES installer 100 may survey a portion of the surface (and sub-surface) ahead of the mobile SES installer 100, at step 414. For instance, the mobile SES installer 100 may include the geologic mapping sensor 140 that may survey (e.g., by sonar, seismic, GPR or otherwise) the surface and sub-surface. A model (e.g., 2D or 3D or both) may be generated, for example, by the solar energy system installer module 168 on the computer 130 and displayed to the driver of the mobile SES installer 100 (or other user). At step 416, a determination is made whether an obstruction (e.g., geologic obstruction 216) is at or near the second proposed installation location. If not, then the mobile SES installer 100 is directed to the second proposed installation location at step 422.

If there is an obstruction detected at or near the second proposed installation location, then a determination is made whether the obstruction can be graded and/or removed at step 418. For example, as shown in the illustrated mobile SES installer 100, if the obstruction can be graded by the dozer blade 150 and/or removed by the backhoe 148, then the obstruction is graded and/or removed at step 420. The mobile SES installer 100 is then directed to the second proposed installation location at step 422. Determination of whether the obstruction can be graded and/or removed (e.g., by a human controller, the solar energy system installer module 168 on the computer 130, or other software and/or hardware) may depend on, for example, the size, weight, dimensions, type, and/or contents of the obstruction. Such data may be gathered, for instance, by visual inspection of the obstruction from the model and/or based on one or more electronic signals used to generate the model, such as the seismic, sonar, or radar signals.

If the obstruction cannot be graded by the dozer blade 150 and/or removed by the backhoe 148, then a new proposed installation location (without an obstruction) is determined to replace the second proposed installation location at step 424 (e.g., by a human controller, the solar energy system installer module 168 on the computer 130, or other software and/or hardware). The new proposed installation location may be within the same macro position as the second proposed installation location but at a different micro position. Alternatively, the new proposed installation location may be at a different macro position as the second proposed installation location. The mobile SES installer 100 is then directed to the new proposed installation location at step 426.

Once the mobile SES installer 100 is at the new proposed installation location after step 426, or at the second proposed installation location after step 422, the mobile SES installer 100 is used to perform a first operation at the new (or second) proposed installation location at step 428. The mobile SES installer 100 next is used to perform a second operation at the new (or second) proposed installation location at step 430.

A number of implementations have been described. Nevertheless, it will be understood that various modifications may be made. For example, while some embodiments have been described and/or illustrated in terms of heliostats, other solar energy members, such as PV cells, may also be utilized in accordance with the present disclosure. In addition, additional or fewer components may be mounted on or included with the example mobile SES installer 100. For example, the mobile SES installer 100 may include a camera (e.g., still and/or video) for capturing images during one or more operations of the mobile SES installer 100. The images may be transmitted (e.g., by the communication module 142) to a location remote from the mobile SES installer 100, such as, for example, the remote station 172. Further, methods 300 and 400 may include less steps than those illustrated or more steps than those illustrated. In addition, the illustrated steps of methods 300 and 400 may be performed in the respective orders illustrated or in different orders than that illustrated. For example, the mobile SES installer 100 may detect an obstruction at or near a second proposed installation location as in step 416 prior to or at the first proposed installation location. In other words, steps 416 through 426 may be performed prior to or at any proposed installation location, including the first proposed installation location. Other variations in the order of steps is also possible. Accordingly, other implementations are within the scope of the following claims.

What is claimed is:

1. A mobile apparatus for installing solar energy system components, comprising:
a mobile vehicle operable to traverse a terranean surface;
one or more installers mounted to the mobile vehicle, each installer configured to move in at least two degrees of freedom relative to the terranean surface and install one or more components of a solar energy system;
a power module coupled to the one or more installers, the power module configured to provide operating power to the one or more installers; and
a computer module comprising:
a memory comprising a component installation module; and
one or more processors operable to execute the component installation module, the component installation module operable when executed to:
direct the mobile vehicle to a macro-position of a location on the terranean surface suitable for installation of the solar energy system;
at the macro-position of the location, adjust at least one of the installers to a micro-position of the location within the macro-position; and
direct an operation of the adjusted installer to install a component of the solar energy system at the micro-position of the location.

2. The apparatus of claim 1, further comprising one or more terranean-modifying devices mounted to the mobile vehicle, each terranean-modifying device configured to move in at least two degrees of freedom relative to the terranean surface, wherein the component installation module is operable when executed to direct an operation of the one or more terranean-modifying devices at or near the plurality of locations.

3. The apparatus of claim 2, wherein at least one of the terranean-modifying devices is an auger or a tamping system.

4. The apparatus of claim 2, wherein the one or more terranean-modifying devices are mounted to a front end of the mobile vehicle in a first rack, and the one or more installers are mounted to a back end of the mobile vehicle in a second rack.

5. The apparatus of claim 4, wherein at least one of the first or second rack is movable in at least two degrees of freedom relative to the corresponding end of the mobile vehicle.

6. The apparatus of claim 1, wherein at least one of the installers is a vibration post installer.

7. The apparatus of claim 1, wherein the power module comprises at least one of:
a battery configured to supply electrical power to at least one of the one or more post installers, and the computer module; or
a photovoltaic panel configured to supply electrical power to at least one of the battery or the computer module.

8. The apparatus of claim 1, wherein the mobile vehicle comprises a human-operable vehicle.

9. The apparatus of claim 1, further comprising a wireless antenna communicably coupled to the computer module, the wireless antenna configured to receive data from a location remote from the vehicle, the data comprising instructions operable when executed by the one or more processors to perform operations comprising:
modifying at least a portion of the component installation module.

10. The apparatus of claim 9, wherein the instructions are further operable when executed by the one or more processors to perform operations comprising:
managing the component installation module to direct the mobile vehicle to the plurality of locations on the terranean surface; and
managing the component installation module to direct an operation of the one or more installers to install a support post into the terranean surface.

11. The apparatus of claim 1, wherein each of the installers is individually movable in at least two degrees of freedom relative to the vehicle and relative to the other installers in the plurality of installers.

12. The apparatus of claim 11, wherein at least one of the plurality of installers is individually movable in six degrees of freedom relative to the vehicle.

13. The apparatus of claim 1, further comprising a GPS module configured to determine a location of the mobile vehicle on the terranean surface.

14. The apparatus of claim 1, further comprising a signal generator configured to transmit a plurality of signals toward a location of the terranean surface ahead of the mobile vehicle during traversal of the terranean surface, and receive a plurality of reflected signals from the location, and wherein the component installation module is further operable when executed to:
receive the plurality of reflected signals from the signal generator;
transform the plurality of reflected signals to one or more images representative of one or more physical characteristics of the terranean surface or a subterranean zone; and
generate a model of at least a portion of the terranean surface or the subterranean zone using the one or more images.

15. The apparatus of claim 14, wherein the plurality of signals comprise one of:
acoustic wave signals;
light wave signals; or
radio frequency wave signals.

16. The apparatus of claim 1, wherein the mobile vehicle comprises an articulated frame having at least two portions.

17. The apparatus of claim 1, wherein the mobile vehicle is configured to tow a storage vehicle, and at least one of the mobile vehicle or the storage vehicle is configured to store:
one or more components of the solar energy system; and
one or more components used to install the solar energy system.

18. The apparatus of claim 1, further comprising at least one of:
a dozer blade mounted to the mobile vehicle and configured to grade the terranean surface during traversal of the terranean surface by the mobile vehicle; or
a backhoe mounted to the mobile vehicle and configured to move at least a portion of the terranean surface.

19. A method for installing at least a portion of a solar energy system, comprising:
determining, with a computing system, a plurality of locations on a terranean surface, each of the plurality of locations suitable for a solar energy system installation relative to at least one other location in the plurality of locations;
for each location, directing a mobile vehicle to a macro-position of the location, the mobile vehicle comprising one or more installers mounted to the mobile vehicle;
at the macro-position of the location, adjusting at least one of the installers to a micro-position of the location within the macro-position; and
directing an operation of the adjusted installer to install a component of the solar energy system at the micro-position of the location.

20. The method of claim 19, wherein the component is a support post configured to support a solar power member.

21. The method of claim 19, wherein the mobile vehicle further comprises one or more augering devices mounted to the mobile vehicle, each augering device configured to form a borehole in the terranean surface, the method further comprising:
for at least one location, directing an operation of the one or more of the augering devices to form a borehole in the terranean surface at or near the location.

22. The method of claim 21, wherein directing an operation of the one or more installers to install a support post in the terranean surface comprises directing an operation of the one or more installers to install the support post in the borehole.

23. The method of claim 19, further comprising:
dynamically adjusting the micro-position as the mobile vehicle is arriving or at the macro-position; and
directing the operation of the one or more installers to install the component at the adjusted micro-position.

24. The method of claim 23, further comprising:
graphically displaying each location to a user of the mobile vehicle;
guiding the user towards each location through the graphical display; and
providing an indication to the user that the mobile vehicle has arrived at the macro-position.

25. The method of claim 23, further comprising:
transmitting a plurality of signals ahead of the mobile vehicle toward the location in the plurality of locations suitable for a solar energy system installation;
receiving a plurality of reflected signals from the location representative of one or more physical characteristics of the proposed location; and
automatically adjusting at least one of the macro-position of the location or the micro position of the location based on the one or more physical characteristics of the location.

26. The method of claim 25, further comprising:
transforming the plurality of reflected signals to one or more images representative of one or more physical characteristics of the terranean surface; and
displaying the one or more images on a graphical user interface.

27. The method of claim 26, wherein the one or more images comprise three-dimensional images.

28. The method of claim 19, wherein determining a plurality of locations on a terranean surface, each of the plurality of locations suitable for a solar energy system installation relative to at least one other location in the plurality of locations, comprises:
receiving data at the mobile vehicle indicating global positioning coordinates of at least a portion of the plurality of locations.

29. The method of claim 23, further comprising:
automatically determining a macro-position of a next location suitable for installation of a solar energy system different than a previous location;
directing the mobile vehicle to the next location; and
determining a micro-position of the next location.

30. The method of claim 29, wherein automatically determining a macro-position of a next location suitable for installation of a solar energy system different than a previous location comprises at least one of:
receiving data at the mobile vehicle indicating global positioning coordinates of the next location;
calculating global positioning coordinates of the next location based on a differential in global positioning coordinates between the previous location and a location of a solar energy receiver; or
calculating global positioning coordinates of the next location based on a substantially fixed differential from the previous location.

31. The method of claim 23, wherein directing the operation of the one or more installers to install the support post in the terranean surface at the micro-position comprises at least one of:
moving a rack that is mounted to the mobile vehicle and supports the one or more installers in at least two degrees of freedom relative to the mobile vehicle; or
moving at least one installer in at least two degrees of freedom relative to the rack.

32. The method of claim 19, further comprising performing an operation comprising at least one of:
grading at least a portion of the terranean surface with a dozer blade mounted to the mobile vehicle during traversal of the terranean surface by the mobile vehicle;
moving at least a portion of the graded terranean surface by a backhoe mounted to the mobile vehicle; and
dispensing a portion of cement at one of the plurality of locations to supplement the terranean surface.

33. The method of claim 19, further comprising:
generating power on the mobile vehicle; and
supplying the electrical power to one or more of the installers.

34. The method of claim 33, wherein generating power on the mobile vehicle comprises at least one of:
generating hydraulic power with an internal combustion engine of the mobile vehicle; or
generating electrical power by at least one of a solar power photovoltaic cell mounted on the mobile vehicle or the internal combustion engine of the mobile vehicle.
